(19) United States
(12) Patent Application Publication
(10) Pub. No.: US 2006/0063134 A1
(43) Pub. Date: Mar. 23, 2006

(54) Coping for dental restorations and method of forming

(76) Inventor: Mooki Kim, King City, OR (US)

Correspondence Address: MARGER JOHNSON & MCCOLLOM, P.C., 210 SW MORRISON STREET, SUITE 400, PORTLAND, OR, 97204, US

(21) Appl. No.: 10/945,622

(22) Filed: Sep. 20, 2004

(51) Int. Cl. A61C 5/08; A61C 5/10

(52) U.S. Cl. 433/218; 433/222.1; 433/223

(57) ABSTRACT

A dental restoration preferably comprises a light-transmissive coping and a porcelain layer. The light-transmissive coping can be formed using a metal fiber layer rather than a solid metal layer. The metal fiber layer preferably consists of a mixture of metal fibers and an opaque bonding material. The metal fiber layer can further be substantially encapsulated between other layers such that non-precious metals may be used without fear of allergic reactions in patients. A method of forming a dental restoration preferably comprises forming a light-transmissive coping and applying a porcelain shell to the coping.

### BACKGROUND OF THE INVENTION

This invention relates generally to improved dental restorations and methods of producing improved copings for dental restorations. More specifically, this invention relates to a method for easily making copings for dental restorations having improved characteristics and lower cost. It also relates to dental copings having improved characteristics over conventional copings.

Porcelain is the most widely used material for fabricating dental restorations because the color is similar to natural teeth. There are two primary conventional methods for making dental restorations using porcelain-PFM (porcelain fused to metal), which uses a metal coping, and PJC (porcelain jacket crown), which does not use a metal coping.

PFM provides a strong and durable restoration. Unfortunately however, although the metal coping provides strength, it also blocks the transmission of light through the dental restoration and casts a visible shadow in the gum tissue of the patient. This visible discoloration of the gum tissue is aesthetically displeasing.

PJC provides a more aethestically pleasing restoration because it lacks the metal coping and therefore transmits light well. Unfortunately, it is not as strong as PFM and is prone to breaking. While new materials have been developed that provide both strength and light transmission, they are expensive and require specialized equipment such as CAD-CAM, pressing, milling, and/or other complex machinery to process.

Conventional methods also typically require skilled technicians to create the dental copings and restorations. A conventional process for forming a dental coping is known as the lost wax technique. The lost wax technique entails waxing, investing, casting, and metalwork. These steps require a skilled technician.

It would be desirable to have an inexpensive, easy to use method for producing copings for strong, light-transmissive dental restorations.

### SUMMARY OF THE INVENTION

The principles of the present invention preferably combine advantages of the PFM and PJC manufacturing processes to provide strong, light-transmissive copings for dental restorations. The method is also preferably easy to use without the need for expensive, specialized equipment.

According to a preferred embodiment, this can be accomplished, for instance, by using metal fibers rather than solid metal to create a light-transmissive metal coping. The metal fibers (e.g., metal filings, scrapings, or other small pieces of metal) can be implemented in a paste by mixing them with an opaque-like bonding material (e.g., opaque material). Using metal fibers provides strength without creating the impermeable light barrier created by a solid metal coping. Because light is permitted to pass through, the dental restoration having a coping formed using metal fibers is not as dark as conventional PFM restorations. Accordingly, a dental restoration having a coping formed according to a preferred method is stronger than those formed through the conventional PJC process and more aesthetically pleasing than those formed using the conventional PFM method.

According to another aspect of the present invention, a method of making a coping for a dental restoration preferably includes forming a refractory die to duplicate a master die. The surface of the refractory die is then preferably sealed with porcelain material and baked. The die is preferably covered with an inner blocking material such as metal fiber oxide and baked again. Next, the die can be covered with a mixture of metal fiber and an opaque material (to a creamy consistency) and baked again. A layer of opaque material is then preferably applied over the metal fiber mixture to seal in the metal oxide of the fibers and baked. The entire surface is then preferably covered with a porcelain material and baked again. Porcelain material is then preferably applied again and baked to compensate for shrinkage. The refractory die material is preferably sandblasted out of the coping to leave a strong, aesthetically pleasing dental coping.

### BRIEF DESCRIPTION OF THE DRAWINGS

FIGS. 1-8 are schematic diagrams illustrating a process for making an improved dental coping according to an embodiment of the present invention;

FIG. 9 is a schematic illustration of an improved dental coping, constructed according to the process of FIGS. 1-8; and

FIG. 10 is a schematic cutaway view of the improved dental coping of FIG. 9, showing a layered structure of the dental coping.

### DETAILED DESCRIPTION

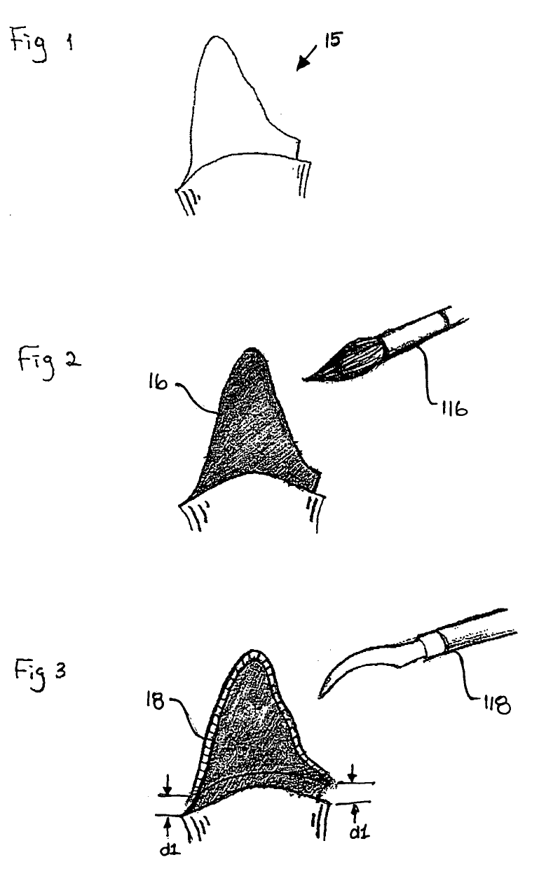

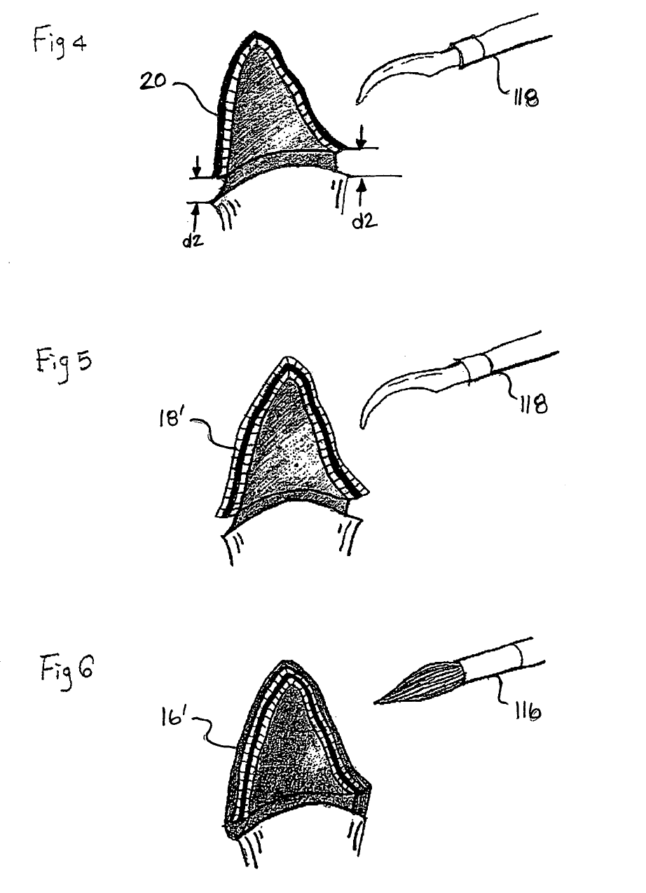

A preferred process of forming a dental coping 100 (see FIG. 9) according to various principles of the present invention will now be described more fully with reference to FIGS. 1-8. Referring to FIG. 1, a process for making an improved dental coping preferably begins similar to a conventional method by duplicating a master die of a tooth to create a refractory die 15. As illustrated in FIG. 2, the surface of the refractory die 15 is then preferably covered with a porcelain material 16 using a brush or other applicator 18 and then baked in an oven.

Referring now to FIG. 3, the die 15 is then preferably covered beginning a distance “d1” (e.g., approximately 1 mm) above the margin with an opaque inner blocking material 18 (which can assist in sealing in metal fiber oxide) using an applicator 118 and then baked again. As illustrated in FIG. 4, the die 15 is then preferably covered, beginning a distance “d2” (e.g., approximately 1-2 mm) above the margin, with a mixture 20 of metal fibers and opaque material. The mixture 20 of metal fibers with opaque materials preferably has a creamy consistency. The choice of metals and the mixing ratio of fiber to opaque material can be determined based on a desired strength and opacity for a given patient.

The metal fibers can, for example, be metal filings. The metal fiber can be any metal, and does not need to be a precious metal. Non-precious metals that form oxides may, in fact, be desirable because the oxides provide increased bonding with porcelain. The metal fibers can also be cross-cut or acid etched to create increased retention with each other and therefore stronger bonding. The metal fibers can also be baked at a high temperature to degas them and remove any contaminants. After application of the metal fiber/opaque mixture layer 20, the die 15 is then preferably baked again.

Referring to FIG. 5, another layer of opaque material 18′ is preferably applied to the die 15 over the area covered by the mixture 20 of metal fiber and opaque material to block the color of metal oxide from the metal fibers applied earlier. The die 15 is then preferably baked again.

The entire surface of the die 15 is then preferably covered with porcelain material 16′, as shown in FIG. 6. The die 15 is then baked again. Referring to FIG. 7, porcelain material 16″ can be reapplied to compensate for shrinkage of the porcelain 16′ during the baking process. The die 15 can then be rebaked. This process can be repeated as necessary to obtain the appropriately-sized coping. Once the dental coping 100 has been formed to the desired size, the refractory die material 15 is preferably removed from the coping 100 (for example, through sandblasting using a sandblaster 120), as illustrated in FIG. 8. During formation of the dental coping 100, the temperature of the baking processes can be reduced for each subsequent baking process.

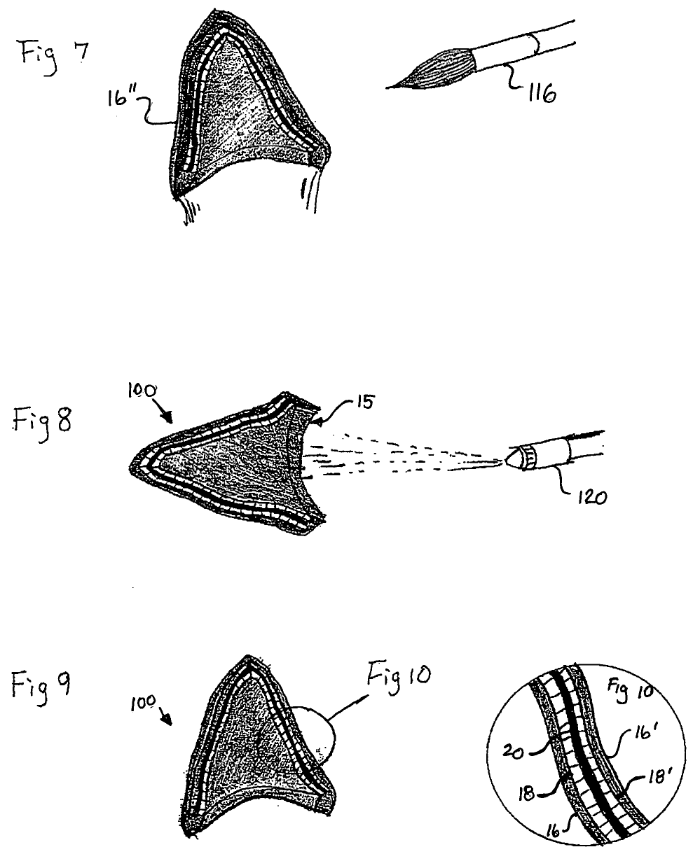

FIGS. 9 and 10 illustrate a dental coping 100 formed using the improved method of FIGS. 1-8. Referring to FIGS. 9 and 10, a dental coping 100 constructed according to various preferred principles of the present invention, preferably includes a plurality of layers, including, for instance, an opaque material layer 18, a metal fiber layer 20, another opaque layer 18′, and a porcelain layer 16′. An inner porcelain layer 16 can also be provided.

A dental coping 100 constructed according to the principles of the present invention can provide several benefits over conventional copings. For instance, the above-described method can be implemented without the use of any specialized equipment. Furthermore, the process is simple and easy to perform and therefore does not require a skilled technician to implement. The resulting dental coping 100 therefore provides a strong, aesthetically-pleasing restoration that is relatively inexpensive.

By incorporating metal fibers into the coping, the restoration is strong and durable. Also, by using metal fibers, coefficients of thermal expansion are less important because the metal fiber layer will be much more forgiving than a solid metal layer. It should also be noted that since the metal fibers are preferably encapsulated within other layers, there is no need to use expensive precious metal alloys (e.g., Au, Pt, Pd based alloys). High noble alloys have been used conventionally because some patients exhibit allergic reactions to other metals. By encapsulating the metal fibers, however, little or no metal is exposed to the patient and the resulting restoration can be made safe for use with all patients regardless of their particular sensitivities to metal or metal oxides. Base alloys are most preferable because they provide better bonding with the porcelain and result in a stronger coping.

Furthermore, a dental restoration formed using a coping 100 according to the principles described above is aesthetically pleasing because the coping 100 is light-transmissive. By eliminating the solid metal coping of the conventional PFM method, the dark shadows created on a patient's gum line can be eliminated and the gums thereby retain a brighter, more natural looking appearance.

Of course, various modifications to the above-described embodiments will also provide the beneficial features of the inventive principles disclosed herein. For instance, the fibers need not be metal fibers and can be any other material that provides strength and durability while permitting light to be transmitted through the resulting structure. In addition, a solid coping material can be used and still provide the aesthetic benefits if it is light-transmissive. Various alternative materials that can be used in fiber and/or non-fiber copings include, for instance, zirconia, quartz, aluminum oxide, ceramic, etc.

Having described and illustrated the principles of the invention in a preferred embodiment and various alternative embodiments thereof, it should be apparent that the invention can be modified in arrangement and detail without departing from such principles. For instance, various steps of the process may be modified in arrangement, detail, and order, or may be omitted entirely, and still fall within the spirit and scope of this invention. We therefore claim all modifications and variations coming within the spirit and scope of the following claims.

What is claimed is:

1. A method of making a coping for a dental restoration, said method comprising:
forming a light-transmissive coping; and
applying a porcelain shell to the coping.

2. A method according to claim 1, wherein forming a light-transmissive coping comprises forming a coping comprising metal fibers.

3. A method according to claim 2, further comprising arranging the metal fibers between layers of the dental porcelain to substantially prevent exposure of a patient's mouth to the metal fibers.

4. A method according to claim 3, wherein the metal fibers comprise one or more non-precious metals or precious metal.

5. A method according to claim 2, wherein the metal fibers produce metal oxides that bond with the porcelain shell.

6. A method according to claim 2, wherein the metal fibers are comprised in a mixture of metal fibers and opaque material.

7. A method according to claim 1, further comprising substantially encapsulating a metal coping material between porcelain layers.

8. A mixture for forming copings of dental restorations, comprising:
metal fibers; and
an opaque bonding material.

9. A mixture according to claim 8, wherein the metal fibers comprise one or more non-precious metals.

10. A mixture according to claim 8, wherein the metal fibers and opaque material are combined in a manner that is capable of providing strength to a coping for a dental restoration while permitting light transmissiveness of the dental restoration.

11. A method of forming a coping for a dental restoration, comprising:
applying a mixture of metal fibers and opaque material to a die; and
applying a porcelain material to the die.

12. A method according to claim 11, further comprising:
substantially encapsulating the mixture of metal fibers and opaque material between two porcelain layers.

13. A method according to claim 11, further comprising:
arranging a layer of opaque material on each side of a metal fiber layer created by applying a mixture of metal fibers and opaque material to the die.

14. A method according to claim 13, further comprising baking after applying each layer.

15. A method according to claim 14, wherein the temperature of the baking process is reduced for each successive layer.

16. A dental restoration, comprising:
a light-transmissive coping; and
a porcelain shell.

17. A dental restoration according to claim 16, wherein the light-transmissive coping comprises a metal fiber layer.

18. A dental restoration according to claim 16, further comprising a layered structure including a porcelain layer, an opaque layer, a metal fiber layer, and a second porcelain layer.

19. A dental restoration according to claim 17, wherein the metal fiber layer comprises a mixture of metal fibers and an opaque bonding material.

20. A dental restoration according to claim 16, wherein the light-transmissive coping comprises at least one material selected from the group consisting of: metal fibers, ceramic, quartz, aluminum oxide, and zirconia.
